(19) United States
(12) Patent Application Publication
(10) Pub. No.: US 2026/0254735 A1
(43) Pub. Date: Aug. 27, 2026

(54) Measuring Network Experience by Performing Adaptive Tracing of a Cloud Path

(71) Applicant: Zscaler, Inc., San Jose, CA (US)

(72) Inventors: Satish Kalipatnapu, Alpharetta, GA (US); Prasannakumar Jobigenahally Malleshaiah, San Jose, CA (US); Anirudh Achanta, San Jose, CA (US); Vandan Desai, New York, NY (US); Ashok Kolachina, Milpitas, CA (US); Francisco Javier Rodriguez Gonzalez, San Francisco, CA (US); Vikas Srivastava, Columbus, OH (US); Amitkumar Patel, Dublin, CA (US); Tejas Budukh, San Jose, CA (US); Saroj Panigrahy, San Jose, CA (US)

(73) Assignee: Zscaler, Inc., San Jose, CA (US)

(21) Appl. No.: 19/061,248

(22) Filed: Feb. 24, 2025

(51) Int. Cl. H04L 43/026; H04L 43/0829; H04L 43/0864; H04L 43/087

(52) U.S. Cl. CPC H04L 43/026; H04L 43/0829; H04L 43/0864; H04L 43/087

(57) ABSTRACT

Systems and methods for measuring and assigning network experience scores include collecting end-to-end metric data corresponding to application traffic between one or more clients and one or more servers, the metric data including any of latency, jitter, and packet loss; comparing the metric data with baseline percentile values; assigning one or more scores to one or more segments of a path associated with the application traffic based on the metric data and the baseline percentile values; and aggregating the scores of the one or more segments to produce a single network experience score indicative of overall network performance for the application traffic.

### FIELD OF THE DISCLOSURE

The present disclosure relates generally to networking and computing. More particularly, the present disclosure relates to systems and methods for measuring network experience using adaptive tracing.

### BACKGROUND OF THE DISCLOSURE

Traditionally, network performance assessment has focused on metrics gathered primarily from web-based traffic, overlooking the unique requirements and performance characteristics of non-web applications such as remote desktop protocols, VolP services, and file transfer systems. Existing solutions often rely on limited or generalized measurements without accounting for the distinct network segments or the contextual baseline performance expectations that vary across different geographies and tenants. Moreover, conventional methods don't employ sophisticated approaches, such as machine learning, to predict and proactively address potential network degradation. The present invention addresses these shortcomings by introducing a robust scoring methodology, referred to herein as the “CloudPath” network experience score.

### BRIEF SUMMARY OF THE DISCLOSURE

The present disclosure relates to various techniques for tracing with tunnels and cloud-based systems for determining measures of network performance and experience. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include collecting end-to-end metric data corresponding to application traffic between one or more clients and one or more servers, the metric data including any of latency, jitter, and packet loss; comparing the metric data with baseline percentile values; assigning one or more scores to one or more segments of a path associated with the application traffic based on the metric data and the baseline percentile values; and aggregating the scores of the one or more segments to produce a single network experience score indicative of overall network performance for the application traffic.

The steps can further include segmenting a network path into discrete path segments, each segment corresponding to at least one leg of the network path between the one or more clients and the one or more servers; collecting segment-specific metric data for each segment; determining segment-specific scores by comparing the segment-specific metric data to the baseline percentile values; and combining the segment-specific scores via a weighted aggregation to form the network experience score. The weighted aggregation assigns different weights to at least two path segments based on any of the criticality of each segment to an end-to-end connection, expert analysis regarding network architecture, and a regression analysis establishing correlation between segment performance and overall network performance. The steps can include establishing baseline percentile values for the metric data by analyzing historical network performance information over a defined period, and wherein the defined period for historical data collection includes a rolling window of at least seven consecutive days. The steps can include establishing distinct baselines for a plurality of geographic identifiers associated with different operating regions; and computing the network experience score for each geographic identifier independently based on respective baseline percentile values. The assigning of one or more scores can include establishing scoring bins bounded by deviation values and mapping current metric measurements to a score according to which scoring bin the measurement falls into. The steps can include applying a machine learning model trained on historical network performance data to predict future network experience scores for application traffic, wherein the machine learning model outputs a predicted score based on real-time metric measurements. The steps can include periodically retraining the machine learning model with newly collected metric data to maintain or improve the accuracy of predicted network experience scores.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a cloud-based system offering security as a service.

FIG. 2 is a network diagram of an example implementation of the cloud-based system.

FIG. 3 is a block diagram of a server that may be used in the cloud-based system of FIGS. 1 and 2 or the like.

FIG. 4 is a block diagram of a user device that may be used with the cloud-based system of FIGS. 1 and 2 or the like.

FIG. 5 is a network diagram of the cloud-based system illustrating an application on user devices with users configured to operate through the cloud-based system.

FIG. 6 is a network diagram of the cloud-based system in an application of digital experience monitoring.

FIG. 7 is a network diagram of a trace between a user and a destination with no tunnel in between.

FIG. 8 is a network diagram of a trace between a user and a destination with an opaque tunnel between a tunnel client and a tunnel server.

FIG. 9 is a graphical representation of latency or packet loss over a selected time period.

FIG. 10 is a graphical representation of a hop view of the present CloudPath feature.

FIG. 11 is a diagram representing latency of a specific application, in a specific geo-ID, for a specific customer.

FIG. 12 is a flowchart of a process for determining and providing network experience scores

### DETAILED DESCRIPTION OF THE DISCLOSURE

The present disclosure relates to systems and methods for measuring network experience using adaptive tracing. Leveraging historical percentile data for baseline calculations, segment-level metric analysis, and machine learning predictions, the present invention provides a more comprehensive, accurate, and proactive framework for evaluating and optimizing network performance for applications. This approach enables targeted diagnostics, improved troubleshooting, and tailored weight assignments across network segments, ultimately enhancing user experience and overall network efficiency.

### § 1.0 Example Cloud-Based System Architecture

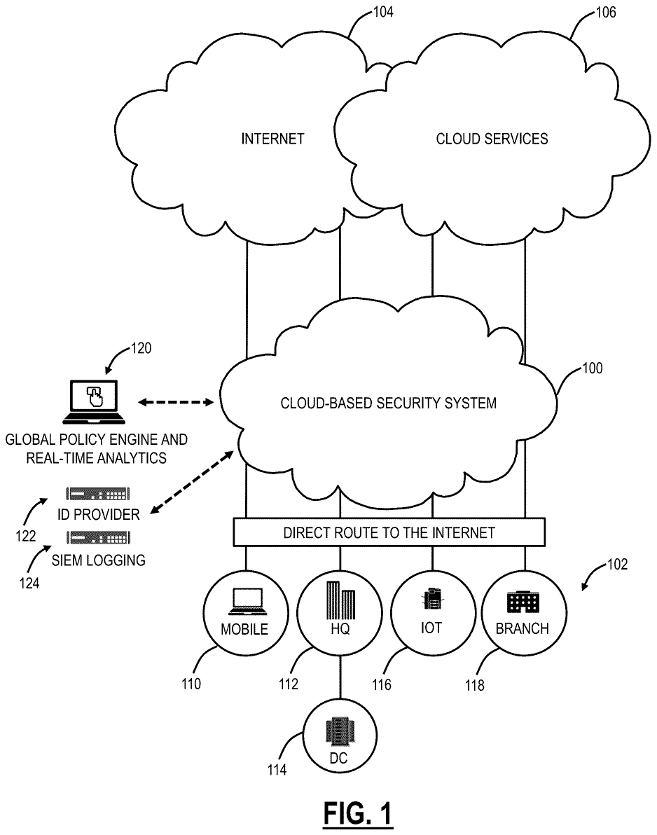

FIG. 1 is a network diagram of a cloud-based system 100 offering security as a service. Specifically, the cloud-based system 100 can offer a Secure Internet and Web Gateway as a service to various users 102, as well as other cloud services. In this manner, the cloud-based system 100 is located between the users 102 and the Internet as well as any cloud services 106 (or applications) accessed by the users 102. As such, the cloud-based system 100 provides inline monitoring inspecting traffic between the users 102, the Internet 104, and the cloud services 106, including Secure Sockets Layer (SSL) traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via a Cloud Access Security Broker (CASB), file type control, etc.

The cloud-based firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc. protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being in a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

For illustration purposes, the users 102 of the cloud-based system 100 can include a mobile device 110, a headquarters (HQ) 112 which can include or connect to a data center (DC) 114, Internet of Things (IOT) devices 116, a branch office/remote location 118, etc., and each includes one or more user devices (an example user device 300 is illustrated in FIG. 5). The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters 112 can include an enterprise's network with resources in the data center 114. The mobile device 110 can be a so-called road warrior, i.e., users that are off-site, on-the-road, etc. Those skilled in the art will recognize a user 102 has to use a corresponding user device 300 for accessing the cloud-based system 100 and the like, and the description herein may use the user 102 and/or the user device 300 interchangeably.

Further, the cloud-based system 100 can be multi-tenant, with each tenant having its own users 102 and configuration, policy, rules, etc. One advantage of the multi-tenancy and a large volume of users is the zero-day/zero-hour protection in that a new vulnerability can be detected and then instantly remediated across the entire cloud-based system 100. The same applies to policy, rule, configuration, etc. changes-they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 116) and the Internet 104 and the cloud services 106. Previously, the IT deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as GRE, L2TP, IPsec, customized tunneling protocols, etc. The devices 110, 116, when not at one of the locations 112, 114, 118 can use a local application that forwards traffic, a proxy such as via a Proxy Auto-Config (PAC) file, and the like. An application of the local application is the application 350 described in detail herein as a connector application. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables IT administrators to have a unified view of user activity, threat intelligence, application usage, etc. For example, IT administrators can drill-down to a per-user level to understand events and correlate threats, to identify compromised devices, to have application visibility, and the like. The cloud-based system 100 can further include connectivity to an Identity Provider (IDP) 122 for authentication of the users 102 and to a Security Information and Event Management (SIEM) system 124 for event logging. The system 124 can provide alert and activity logs on a per-user 102 basis.

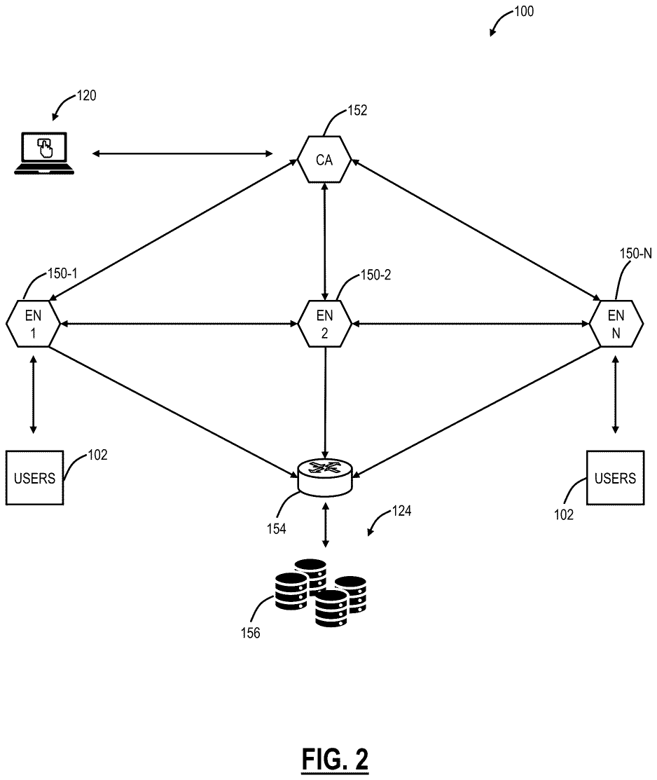

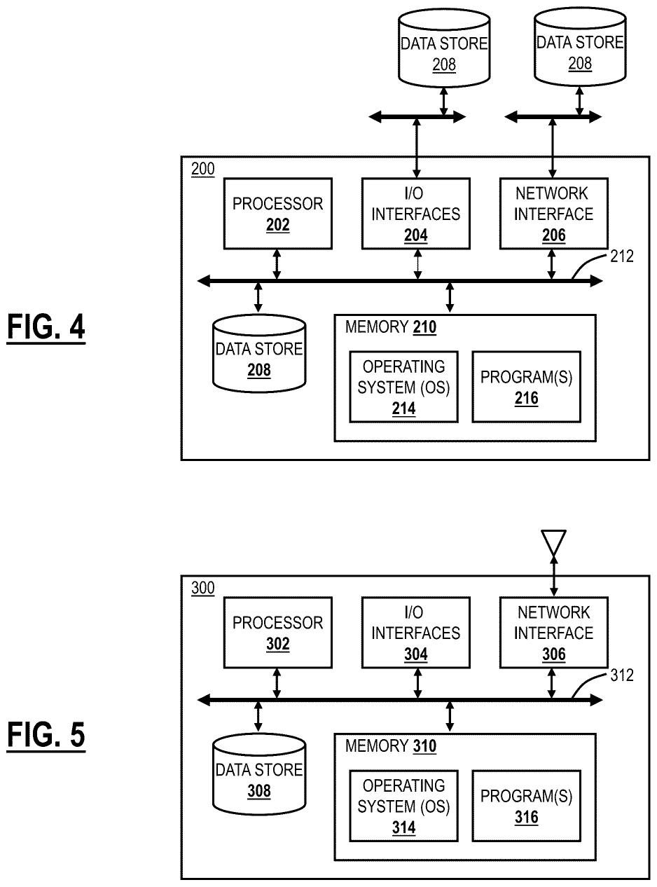

FIG. 2 is a network diagram of an example implementation of the cloud-based system 100. In an embodiment, the cloud-based system 100 includes a plurality of nodes (EN) 150, labeled as nodes 150-1, 150-2, 150-N, interconnected to one another and interconnected to a central authority (CA) 152. The nodes 150 and the central authority 152, while described as nodes, can include one or more servers, including physical servers, virtual machines (VM) executed on physical hardware, etc. An example of a server is illustrated in FIG. 4. The cloud-based system 100 further includes a log router 154 that connects to a storage cluster 156 for supporting log maintenance from the nodes 150. The central authority 152 provide centralized policy, real-time threat updates, etc. and coordinates the distribution of this data between the nodes 150. The nodes 150 provide an onramp to the users 102 and are configured to execute policy, based on the central authority 152, for each user 102. The nodes 150 can be geographically distributed, and the policy for each user 102 follows that user 102 as he or she connects to the nearest (or other criteria) node 150. Of note, the cloud-based system is an external system meaning it is separate from tenant's private networks (enterprise networks) as well as from networks associated with the devices 110, 116, and locations 112, 118.

The nodes 150 are full-featured secure internet gateways that provide integrated internet security. They inspect all web traffic bi-directionally for malware and enforce security, compliance, and firewall policies, as described herein, as well as various additional functionality. In an embodiment, each node 150 has two main modules for inspecting traffic and applying policies: a web module and a firewall module. The nodes 150 are deployed around the world and can handle hundreds of thousands of concurrent users with millions of concurrent sessions. Because of this, regardless of where the users 102 are, they can access the Internet 104 from any device, and the nodes 150 protect the traffic and apply corporate policies. The nodes 150 can implement various inspection engines therein, and optionally, send sandboxing to another system. The nodes 150 include significant fault tolerance capabilities, such as deployment in active-active mode to ensure availability and redundancy as well as continuous monitoring.

In an embodiment, customer traffic is not passed to any other component within the cloud-based system 100, and the nodes 150 can be configured never to store any data to disk. Packet data is held in memory for inspection and then, based on policy, is either forwarded or dropped. Log data generated for every transaction is compressed, tokenized, and exported over secure Transport Layer Security (TLS) connections to the log routers 154 that direct the logs to the storage cluster 156, hosted in the appropriate geographical region, for each organization. In an embodiment, all data destined for or received from the Internet is processed through one of the nodes 150. In another embodiment, specific data specified by each tenant, e.g., only email, only executable files, etc., is processed through one of the nodes 150.

Each of the nodes 150 may generate a decision vector D=[d1, d2, . . . , dn] for a content item of one or more parts C=[c1, c2, . . . , cm]. Each decision vector may identify a threat classification, e.g., clean, spyware, malware, undesirable content, innocuous, spam email, unknown, etc. For example, the output of each element of the decision vector D may be based on the output of one or more data inspection engines. In an embodiment, the threat classification may be reduced to a subset of categories, e.g., violating, non-violating, neutral, unknown. Based on the subset classification, the node 150 may allow the distribution of the content item, preclude distribution of the content item, allow distribution of the content item after a cleaning process, or perform threat detection on the content item. In an embodiment, the actions taken by one of the nodes 150 may be determinative on the threat classification of the content item and on a security policy of the tenant to which the content item is being sent from or from which the content item is being requested by. A content item is violating if, for any part C=[c1, c2, . . . , cm] of the content item, at any of the nodes 150, any one of the data inspection engines generates an output that results in a classification of “violating.”

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The nodes 150 establish persistent connections to the central authority 152 to download all policy configurations. When a new user connects to an node 150, a policy request is sent to the central authority 152 through this connection. The central authority 152 then calculates the policies that apply to that user 102 and sends the policy to the node 150 as a highly compressed bitmap.

The policy can be tenant-specific and can include access privileges for users, websites and/or content that is disallowed, restricted domains, DLP dictionaries, etc. Once downloaded, a tenant's policy is cached until a policy change is made in the management system 120. The policy can be tenant-specific and can include access privileges for users, websites and/or content that is disallowed, restricted domains, DLP dictionaries, etc. When this happens, all of the cached policies are purged, and the nodes 150 request the new policy when the user 102 next makes a request. In an embodiment, the node 150 exchange “heartbeats” periodically, so all nodes 150 are informed when there is a policy change. Any node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud service 106 is any service made available to users on-demand via the Internet, as opposed to being provided from a company's on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), and Zscaler Digital Experience (ZDX), all from Zscaler, Inc. (the assignee and applicant of the present application). Also, there can be multiple different cloud-based systems 100, including ones with different architectures and multiple cloud services. The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services 106 are also contemplated. Also, other types of cloud architectures are also contemplated, with the cloud-based system 100 presented for illustration purposes.

### § 2.0 User Device Application for Traffic Forwarding and Monitoring

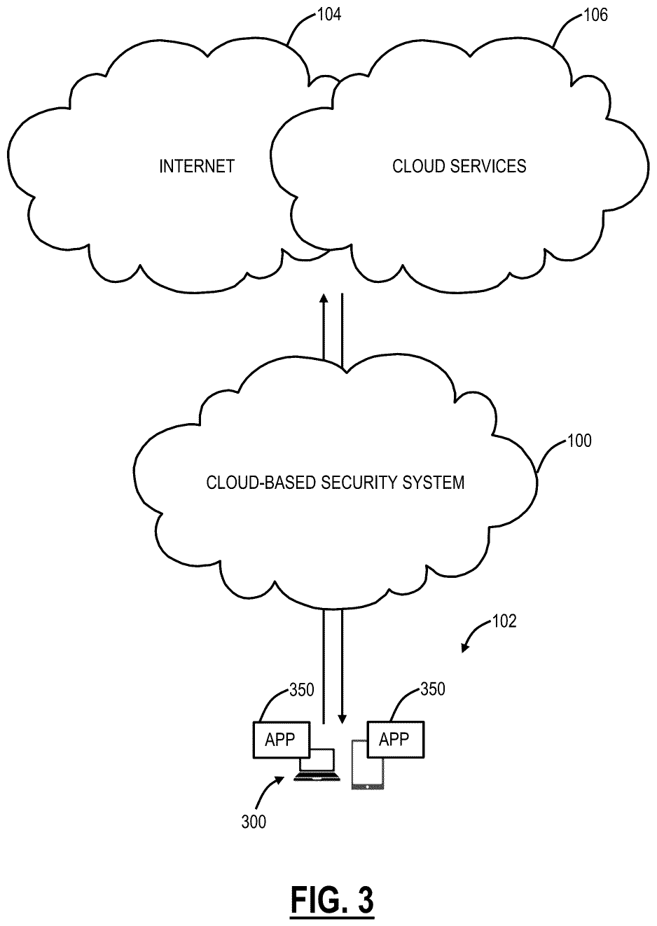

FIG. 3 is a network diagram of the cloud-based system 100 illustrating an application 350 on user devices 300 with users 102 configured to operate through the cloud-based system 100. Different types of user devices 300 are proliferating, including Bring Your Own Device (BYOD) as well as IT-managed devices. The conventional approach for a user device 300 to operate with the cloud-based system 100 as well as for accessing enterprise resources includes complex policies, VPNs, poor user experience, etc. The application 350 can automatically forward user traffic with the cloud-based system 100 as well as ensuring that security and access policies are enforced, regardless of device, location, operating system, or application. The application 350 automatically determines if a user 102 is looking to access the open Internet 104, a SaaS app, or an internal app running in public, private, or the datacenter and routes mobile traffic through the cloud-based system 100. The application 350 can support various cloud services, including ZIA, ZPA, ZDX, etc., allowing the best in class security with zero trust access to internal apps. As described herein, the application 350 can also be referred to as a connector application.

The application 350 is configured to auto-route traffic for seamless user experience. This can be protocol as well as application-specific, and the application 350 can route traffic with a nearest or best fit node 150. Further, the application 350 can detect trusted networks, allowed applications, etc. and support secure network access. The application 350 can also support the enrollment of the user device 300 prior to accessing applications. The application 350 can uniquely detect the users 102 based on fingerprinting the user device 300, using criteria like device model, platform, operating system, etc. The application 350 can support Mobile Device Management (MDM) functions, allowing IT personnel to deploy and manage the user devices 300 seamlessly. This can also include the automatic installation of client and SSL certificates during enrollment. Finally, the application 350 provides visibility into device and app usage of the user 102 of the user device 300.

The application 350 supports a secure, lightweight tunnel between the user device 300 and the cloud-based system 100. For example, the lightweight tunnel can be HTTP-based. With the application 350, there is no requirement for PAC files, an IPsec VPN, authentication cookies, or user 102 setup.

### § 3.0 Example Server Architecture

FIG. 4 is a block diagram of a server 200, which may be used in the cloud-based system 100, in other systems, or standalone. For example, the nodes 150 and the central authority 152 may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 4 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### § 4.0 Example User Device Architecture

FIG. 5 is a block diagram of a user device 300, which may be used with the cloud-based system 100 or the like. Specifically, the user device 300 can form a device used by one of the users 102, and this may include common devices such as laptops, smartphones, tablets, netbooks, personal digital assistants, MP3 players, cell phones, e-book readers, loT devices, servers, desktops, printers, televisions, streaming media devices, and the like. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 5 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100.

### 5.0 Digital Experience Monitoring

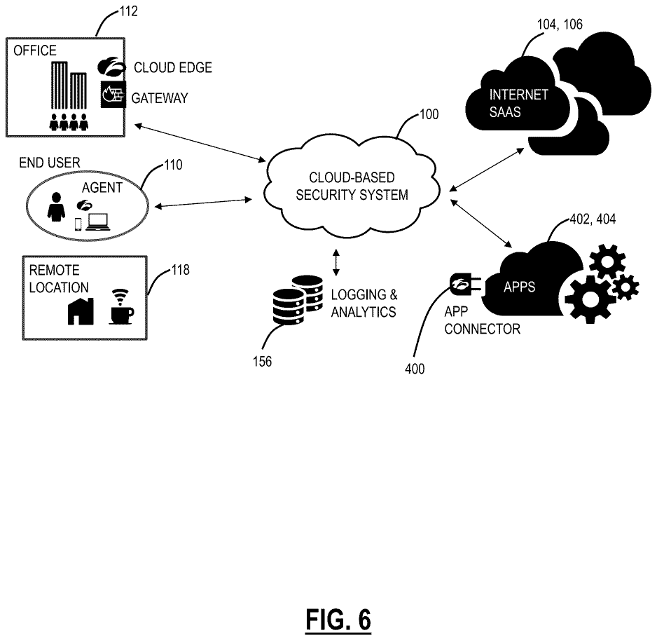

FIG. 6 is a network diagram of the cloud-based system 100 in an application of digital experience monitoring. Here, the cloud-based system 100 providing security as a service as well as ZTNA, can also be used to provide real-time, continuous digital experience monitoring, as opposed to conventional approaches (synthetic probes). A key aspect of the architecture of the cloud-based system 100 is the inline monitoring. This means data is accessible in real-time for individual users from end-to-end. As described herein, digital experience monitoring can include monitoring, analyzing, and improving the digital user experience.

The cloud-based system 100 connects users 102 at the locations 110, 112, 118 to the applications 402, 404, the Internet 104, the cloud services 106, etc. The inline, end-to-end visibility of all users enables digital experience monitoring. The cloud-based system 100 can monitor, diagnose, generate alerts, and perform remedial actions with respect to network endpoints, network components, network links, etc. The network endpoints can include servers, virtual machines, containers, storage systems, or anything with an IP address, including the Internet of Things (IOT), cloud, and wireless endpoints. With these components, these network endpoints can be monitored directly in combination with a network perspective. Thus, the cloud-based system 100 provides a unique architecture that can enable digital experience monitoring, network application monitoring, infrastructure component interactions, etc. Of note, these various monitoring aspects require no additional components-the cloud-based system 100 leverages the existing infrastructure to provide this service.

Again, digital experience monitoring includes the capture of data about how end-to-end application availability, latency, and quality appear to the end user from a network perspective. This is limited to the network traffic visibility and not within components, such as what application performance monitoring can accomplish. Networked application monitoring provides the speed and overall quality of networked application delivery to the user in support of key business activities. Infrastructure component interactions include a focus on infrastructure components as they interact via the network, as well as the network delivery of services or applications. This includes the ability to provide network path analytics.

The cloud-based system 100 can enable real-time performance and behaviors for troubleshooting in the current state of the environment, historical performance and behaviors to understand what occurred or what is trending over time, predictive behaviors by leveraging analytics technologies to distill and create actionable items from the large dataset collected across the various data sources, and the like. The cloud-based system 100 includes the ability to directly ingest any of the following data sources network device-generated health data, network device-generated traffic data, including flow-based data sources inclusive of NetFlow and IPFIX, raw network packet analysis to identify application types and performance characteristics, HTTP request metrics, etc. The cloud-based system 100 can operate at 10 gigabits (10G) Ethernet and higher at full line rate and support a rate of 100,000 or more flows per second or higher.

The applications 402, 404 can include enterprise applications, Office 365, Salesforce, Skype, Google apps, internal applications, etc. These are critical business applications where user experience is important. The objective here is to collect various data points so that user experience can be quantified for a particular user, at a particular time, for purposes of analyzing the experience as well as improving the experience. In an embodiment, the monitored data can be from different categories, including application-related, network-related, device-related (also can be referred to as endpoint-related), protocol-related, etc. Data can be collected at the application 350 or the cloud edge to quantify user experience for specific applications, i.e., the application-related and device-related data. The cloud-based system 100 can further collect the network-related and the protocol-related data (e.g., Domain Name System (DNS) response time).

Application-related data

| | |
|---|---|
| Page Load Time | Redirect count (#) |
| Page Response Time | Throughput (bps) |
| Document Object Model (DOM) | Total size (bytes) |
| Load Time | |
| Total Downloaded bytes | Page error count (#) |
| App availability (%) | Page element count by category (#) |

Network-related data

| | |
|---|---|
| HTTP Request metrics | Bandwidth |
| Server response time | Jitter |
| Ping packet loss (%) | Trace Route |
| Ping round trip | DNS lookup trace |
| Packet loss (%) | GRE/IPSec tunnel monitoring |
| Latency | MTU and bandwidth measurements |

Device-related data (endpoint-related data)

| | |
|---|---|
| System details | Network (config) |
| Central Processing Unit (CPU) | Disk |
| Memory (RAM) | Processes |
| Network (interfaces) | Applications |

Metrics could be combined. For example, device health can be based on a combination of CPU, memory, etc. Network health could be a combination of Wi-Fi/LAN connection health, latency, etc. Application health could be a combination of response time, page loads, etc. The cloud-based system 100 can generate service health as a combination of CPU, memory, and the load time of the service while processing a user's request. The network health could be based on the number of network path(s), latency, packet loss, etc.

The lightweight connector 400 (application connector) can also generate similar metrics for the applications 402, 404. In an embodiment, the metrics can be collected while a user is accessing specific applications that user experience is desired for monitoring. In another embodiment, the metrics can be enriched by triggering synthetic measurements in the context of an inline transaction by the application 350 or cloud edge. The metrics can be tagged with metadata (user, time, app, etc.) and sent to a logging and analytics service for aggregation, analysis, and reporting. Further, network administrators can get UEX reports from the cloud-based system 100. Due to the inline nature and the fact the cloud-based system 100 is an overlay (in-between users and services/applications), the cloud-based system 100 enables the ability to capture user experience metric data continuously and to log such data historically. As such, a network administrator can have a long-term detailed view of the network and associated user experience.

### § 6.0 Traceroute

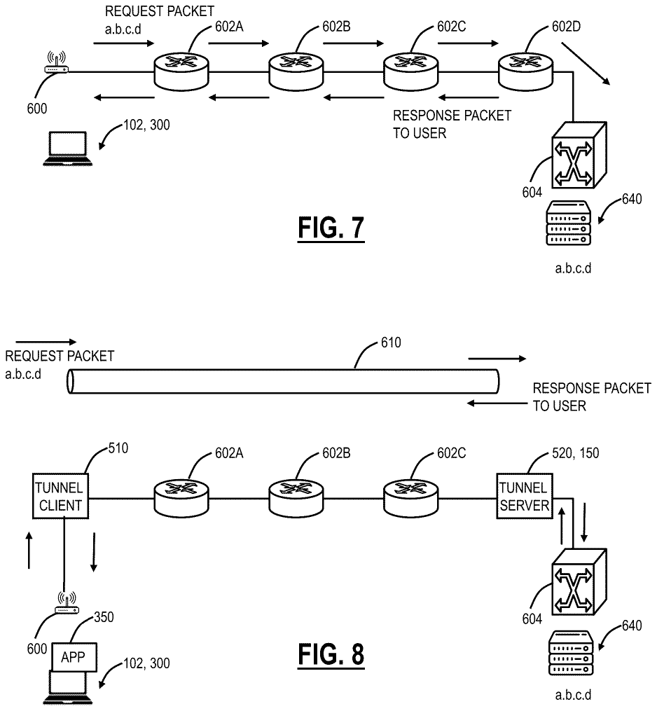

Traceroute can be based on Internet Control Message Protocol (ICMP), TCP, User Datagram Protocol (UDP), etc. For example, a traceroute based on ICMP provides all hops on the network. TCP and UDP are also supported by most clients, if ICMP is blocked. The response from the traceroute provides a holistic view of the network with packet loss details and latency details. FIG. 7 is a network diagram of a traceroute between a user 102 and a destination 640 with no tunnel in between. Here, the user 102 (via a user device 300) connects to an access point 600, which connects to the destination 640 via routers 602A-602D and a switch 604. The traceroute includes transmitting a request packet from the user 102 to the destination 640 (with an address of a.b.c.d) via the access point 600, the routers 602, and the switch 604. Each of these intermediate devices 600, 602, 604 process the request packet and the node 150 sends a response packet back to the user 102, which is also processed by the intermediate devices 600, 602, 604. Accordingly, all hops in the network are visible.

FIG. 8 is a network diagram of a trace between a user 102 and the destination 640 with an opaque tunnel 610 between a tunnel client 510 and a tunnel server 520. The opaque tunnel 610 can be the tunnel 500 as well as a GRE, IPsec, VPN, etc. The opaque tunnel 610 is referred to as opaque because there is no visibility into the tunnel. The traceroute in FIG. 8, based on ICMP, TCP, UDP, etc., provides visibility of the hops before and after the opaque tunnel 610, but does not provide visibility in the opaque tunnel 610. There are no details about packet loss or latency while tunneled transmission. Also, the opaque tunnel 610 can be referred to as an overlay tunnel.

Traceroute includes a series of packets that are exchanged from a probe initiator along a path. Each trace packet includes an increasing TTL value. When a node along the path receives a trace packet where the TTL expires, it sends a response. Based on all of the responses, it is possible for the probe initiator (e.g., the client) to determine the network hops, the latency at each hop, packet loss, and other details. Again, the traceroute can be a My Traceroute (MTR), which also includes PING functionality. Again, MTR is used to traceroute the destination to show the latency, packet loss, and hop information between an initiator and destination. It helps to understand the network status and diagnose network issues.

In an embodiment, MTR is implemented on the user device 300, such as through the application 350, and on the tunnel server 520 and/or the node 150. As is described herein, there is a requirement to implement probes at two points in the service path-at the client and at the tunnel server 520 and/or the node 150. The MTR implementation can support ICMP, UDP, and/or TCP. For ICMP, two sockets are used to send and receive probes, and the ICMP sequence number in reply messages are used to match ICMP request messages. For UDP, one UDP socket is created to send UDP probes, and one ICMP socket is created to receive ICMP error messages. For TCP, one raw socket is created to send TCP probes, and one ICMP socket is created to receive ICMP error messages, and the TCP socket is also used to receive SYN-ACK/RST from the destination. The foregoing functionality can be performed by the application 350 on the user device 300 and a tracing service on the node 150. SYN=Synchronize, ACK=Acknowledgment, and RST=Reset.

### § 7.0 Adaptive tracing, aka “CloudPath”

The present disclosure includes an approach, using the cloud-based system 100 and the user device 300, for adaptively finding the protocol that works best for the internal network and the destination 640. This approach can be implemented in a software module that detects the best protocol (e.g., TCP, UDP, ICMP, etc.) by checking which protocol could reach the destination and which protocol provides the result by checking which protocol provides Least Average latency, Least Average Loss, and Number of Hops found. The module can be implemented in the user device 300, communicating to the cloud-based system 100.

In this approach, egress means the exit of the network and the destination means the final target for the trace. The application 350 is able to identify the Client egress through the REST API call that the client connector makes the to one of the nodes 150.

Trace policy is provided from the cloud-based system 100. The policy specifies a starting hop, ending hop, protocols to be used for egress and destination, number of packets to send, delay between the packets, UDP and TCP ports for egress and destination, destination domain or IP, intervals to be used by the application 350, and the default protocol to used for egress and destination in case of failure. The policy also specifies the detection technique-least latency, least loss, or the number of hops found, that can be used to find the best protocol for the target.

### § 7.1 Automatic Operation

The adaptive protocol module runs without manual intervention when there is an egress change or a gateway IP change on the user device 300 or at the configured interval if there is no change in the egress and gateway. The module runs before the actual trace to find the best protocol to the destination, through traces performed in the different protocols for the purpose of finding the best results. The module then finds the protocol to use and then performs the actual trace using the protocol. The adaptive protocol module can be part of the application 350 on the user device as well as in one of the nodes 150. That is, the techniques described herein can be performed at the user device 300 and at the node 150.

### § 7.2 Adaptive Protocol Detection for the Internal Network

The module can detect the egress through a call to one of the nodes 150 in the cloud-based system 100 which can provide the egress IP. The adaptive trace module finds the best protocol to use for the trace to the egress by sending probes using TCP, UDP, and

ICMP protocol. The detection is triggered on egress or a gateway change or at the end of the configured interval if there is no change in egress or gateway. The module checks which protocol can reach the egress IP by doing a trace to the Egress IP. The module detects the best protocol by checking which protocol could reach the egress, evaluating least latency, least loss, and/or the number of hops found.

For example, this protocol detection step can include sending trace probes using different protocols to the egress IP, e.g., TCP, UDP, and ICMP protocol. The results are evaluated, namely the results will either be a failure or success with results for latency, loss, and number of hops. In an embodiment, if multiple protocols are successful, the module selects the one with the least latency and/or least loss and/or based on the number of hops found. The selected protocol is noted for this egress IP (internal network). The adaptive module caches this information for the configured internal. At the end of this interval, it can again detects the best protocol to be used on the internal network for the trace.

### § 7.3 Adaptive Protocol Detection for the Destination

In a similar manner as protocol detection for the internal network, the module can find the best protocol to use for the trace to the destination 640 by sending probes by doing traces one by one using the configured protocols. The module checks which protocol can reach the destination IP. The module detects the best protocol by checking which protocol could reach the egress-with the least latency and/or least loss and/or based on the number of hops found. If the destination 640 could not be reached using either TCP, UDP, or ICMP protocol then it gives the default protocol, which comes in the policy, as the protocol to be used for the destination.

The Adaptive Trace, aka “CloudPath” or a trace of a “cloud path”, is called to detect the best protocol to reach the destination. The protocol result from the Adaptive Trace module is used for doing a trace to the destination.

### § 7.4 Adaptive Protocol Detection for the Cloud Nodes

The module also detects if the request will go through the cloud-based system 100, and passes the protocol type as adaptive, and the node 150 finds the best protocol to be used for reverse trace to the egress as well the best protocol to be used for forward trace to the destination.

### § 7.5 Results

For the direct case where the trace is not through the cloud-based system 100, the application 350 determines the destination 604 is not through the cloud-based system 100.

The trace module combines the result for the direct case from
1) Trace to Egress using the protocol suggested by the adaptive module, and
2) Trace to the destination using the protocol suggested by the adaptive module.

It creates the Host to the Egress hops using trace results from the internal network and Egress to Destination hops using the results from tracing to the destination. The results are sent to the cloud-based system 100 and the user 102 or administrator can view these results on a dashboard.

The case wherein the trace is through the cloud-based system 100, the application 604 finds the domain goes via the node 150. It combines the results from-
1) Results up to the Egress using protocol suggested by the adaptive module,
2) Results from the node 150 to Egress using the protocol suggested by the adaptive module running on the node 150, and
3) Results from the node 150 to the destination using the protocol suggested by the adaptive module running on the node 150.

The combined results are sent to the cloud-based system 100 and the user 102 or administrator can view these results on a dashboard.

### § 7.6 CloudPath Metrics and Visualizations

The CloudPath feature further offers a detailed visualization of metrics between various hop points along a traffic path. It can capture both direct traffic paths, such as those from the application 350 to the egress to the destination, and paths that tunnel through a ZIA public service edge, such as from the application 350 to the egress to a ZIA public service edge to the destination. The CloudPath feature of the cloud-based system 100 provides several views to analyze these metrics comprehensively.

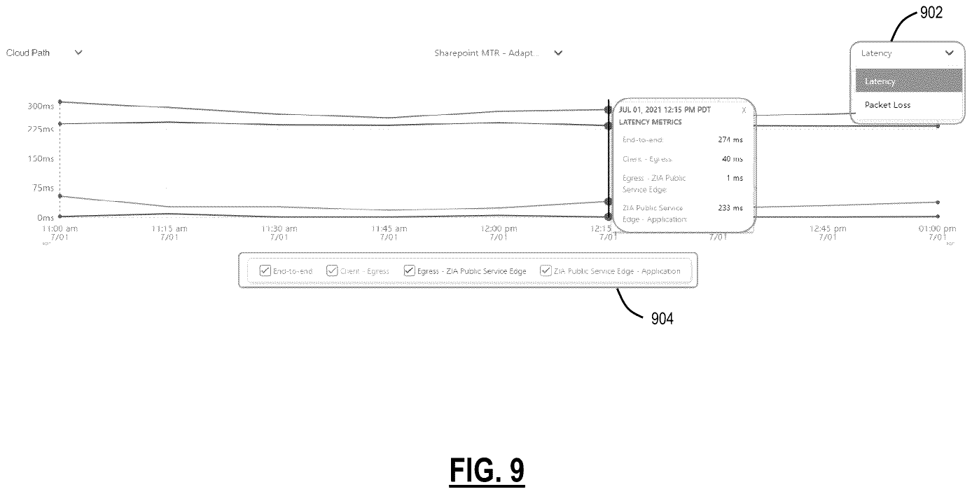

FIG. 9 is a graphical representation of latency or packet loss over a selected time period. The CloudPath feature includes a graphical representation that displays latency or packet loss over a selected time period. Users can choose either latency or packet loss from a drop-down menu 902 to view the corresponding graph. By clicking on a specific point in the graph, users can examine the time period and see the latency in milliseconds or the packet loss percentage. The latency graph also shows metrics for different legs of the path, and users can select additional metrics from checkbox options 904 below the graph. Any errors detected are also displayed. Selecting a point on the graph updates the path being tracked from the device to the application.

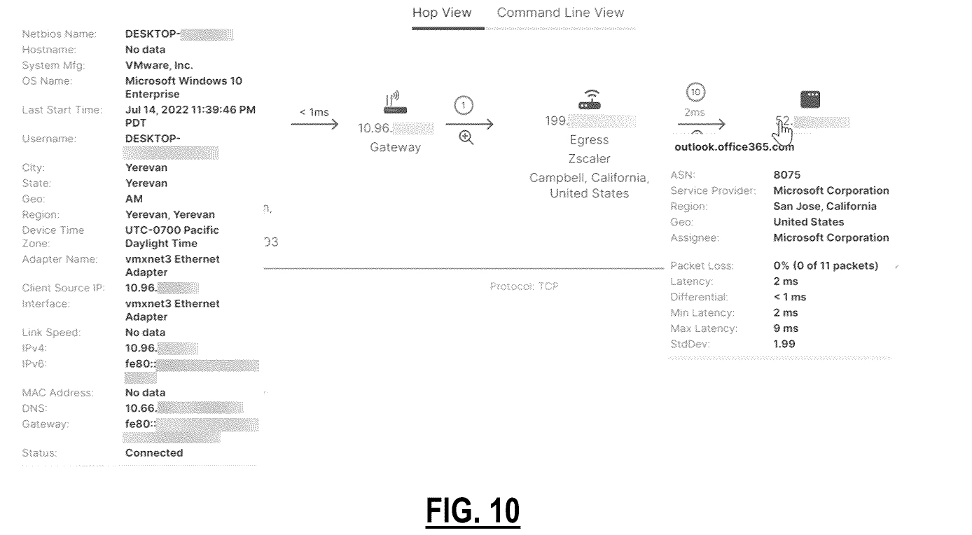

FIG. 10 is a graphical representation of a hop view of the present CloudPath feature. Further, a hop view and command line view provide a detailed breakdown of the path from the user's device to the application or destination. In the hop view, users can hover over different sections of the path to access more detailed information. Arrows on either side of the view allow for expansion. Depending on the section of the path being hovered over, users can see details such as device information, service provider, latency details, packet loss, hop count, and other relevant metrics.

The Command Line View offers a more detailed look at the path. Users can click on this tab to see information about the hop direction (probe direction from the client to the egress IP, from ZIA public service edge or ZIA private service edge to the egress IP, and from service edges to the destination), region and geolocation, packet loss percentage, packets failed, and latency metrics. Any errors present are indicated by an icon next to the IP address.

By providing these comprehensive views and detailed metrics, the CloudPath feature allows users to monitor and analyze network performance effectively. This enables the identification of potential issues along the traffic path and facilitates optimization efforts to improve network reliability and user experience.

### § 8.0 Network Experience Scores

The present systems and methods for calculating a CloudPath network experience score for non-web applications offers a comprehensive approach to measuring network experience. This process involves several key steps. Initially, end-to-end metric data is collected, encompassing a wide range of measurements for non-web application traffic between clients and servers over various network paths. The primary metrics gathered include latency, jitter, and packet loss, with secondary metrics such as the leg protocol and error codes also recorded to provide a detailed understanding of network performance. Next, baseline percentiles are established using historical data collected over a defined period, serving as reference points to understand typical network performance under normal conditions. Current metric measurements are then compared to baseline percentiles, with scores assigned inversely proportional to the percentile rankings of these metrics. Desirable values such as lower latency, jitter, and packet loss receive higher scores, while undesirable higher values receive lower scores. Finally, the individual scores for each metric are aggregated to compute a single CloudPath score, offering a comprehensive representation of the overall network experience for non-web applications. This innovative method extends beyond traditional web-based metrics by utilizing a baseline deviation scoring system, which provides a more accurate and holistic measure of network performance. By leveraging historical data and percentile-based scoring, it ensures that the network experience is evaluated in a context-sensitive manner, reflecting real-world usage and performance variations.

In various embodiments, scoring via individual path segments enhances network performance analysis by scoring and aggregating individual network path segments. This process begins with segmenting the network paths into discrete segments, such as client-to-egress, egress-to-proxy, and proxy-to-server, based on how applications are currently probed, with each leg or group of legs acting as a segment. Metric data is then collected for each segment to measure segment latencies accurately. Following the data collection, scores are assigned to each segment based on their deviation from baseline metric percentiles. For instance, a lower score on a client egress to node 150 segment might indicate issues in reaching a cloud data center. After scoring each segment, the scores are combined using a weighted aggregation method to compute an overall CloudPath score. This weighted aggregation allows for a nuanced understanding of the network's performance, considering the relative importance of each segment. An outstanding aspect of this method lies in its ability to identify specific network segments causing performance issues through detailed segment-level scoring and the strategic use of weighted aggregation. This approach provides a more precise and actionable insight into network performance, enabling targeted troubleshooting and optimization of the network.

Further, in various embodiments, the method includes predicting network experience scores using machine learning which leverages advanced processes to forecast CloudPath scores for non-web applications. The process begins with extensive data collection, gathering key network performance metrics such as latency, packet loss, and jitter. This collected data forms the foundation for training a machine learning model, where the target outcome is an established network experience score. By learning from this historical data, the model becomes adept at recognizing patterns and relationships within the network performance metrics. Once trained, the model can be applied to real-time data to predict CloudPath scores accurately, providing a proactive measure of network experience for non-web applications. To ensure the model remains accurate and effective over time, it is periodically retrained with new data, reflecting any changes or trends in network performance. This innovative approach extends the capability of network experience scoring to non-web applications, offering a predictive, data-driven method to maintain and enhance network performance. By harnessing the power of machine learning, this method provides a sophisticated tool for anticipating network issues and optimizing user experience in a dynamic network environment.

The following provides various use cases for the present network scoring system:

In a scenario where a company relies heavily on remote desktop applications such as Remote Desktop Protocol (RDP), Virtual Network Computing (VNC), and Virtual Desktop Infrastructure (VDI) for employees to access on-premises systems from remote locations, the CloudPath scoring system can be immensely beneficial. The system measures the network performance of these remote desktop sessions by calculating the CloudPath score based on key metrics like latency, jitter, and packet loss. By identifying network segments that cause high latency, the IT team can take targeted actions to optimize the network. This leads to improved responsiveness and a smoother remote desktop experience for users, enhancing productivity and satisfaction.

For businesses that use Voice over Internet Protocol (VOIP) services for their internal and external communications, maintaining high call quality is critical. The CloudPath scoring system evaluates the network paths used by VolP traffic, scoring them based on real-time performance metrics. If the CloudPath score reveals poor network conditions, the IT team can take corrective measures such as rerouting traffic, adjusting Quality of Service (QOS) settings, or troubleshooting specific network segments. These actions can enhance call quality and reduce the occurrence of dropped calls, ensuring reliable and clear communication.

In organizations where large files are transferred between offices using File Transfer Protocol (FTP) servers, slow transfer speeds can significantly impact project timelines. The CloudPath scoring system measures the performance of these FTP transfers and assigns a CloudPath score. By identifying bottlenecks in the network, such as a particular segment consistently scoring low, the organization can take steps to improve transfer speeds. This might involve upgrading the infrastructure or adjusting network configurations, ultimately leading to more efficient file transfers and timely project completion.

Companies that maintain databases replicating data between multiple data centers for redundancy and load balancing can benefit from the CloudPath scoring system. By scoring the network performance of replication traffic, the IT team can ensure data synchronization occurs without significant delays. If the CloudPath score drops, indicating network issues, the team can investigate and resolve the problems promptly. This proactive approach helps maintain data consistency and reliability across data centers.

Finally, enterprises using cloud-based backup solutions to store critical data offsite need to ensure efficient and timely data transfers. The CloudPath scoring system measures the performance of backup data transfers over the network. A low CloudPath score might indicate issues such as slow upload speeds due to network congestion or faulty segments. By identifying and addressing these problems, the IT team can optimize the backup process, ensuring that data is securely stored in the cloud without delays, thereby safeguarding critical information and enhancing data protection strategies.

To illustrate the process of baselining, a specific example is presented. The system baselines metrics on a per-customer basis, per geographic identifier (geo-ID), and the like. In this context, geo-IDs represent all the countries where the customer operates, the customer being one of a plurality of tenants of the cloud-based system 100. For this example, a customer with Germany as the relevant country of operation is selected, and a specific application has been selected for the baselining process. The following calculation represents a method for determining a deviation value.

$$Δ = \frac{p 90 - p 30}{3}$$

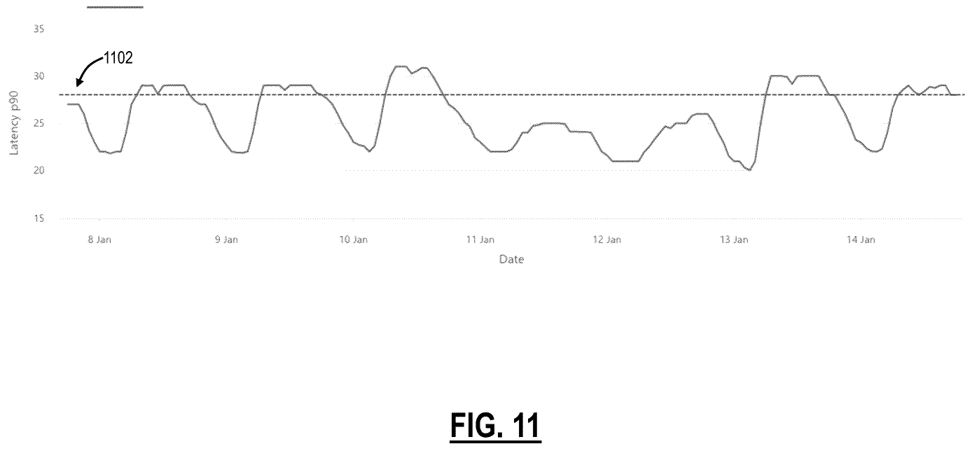

Each metric is scored independently, and these scores are then weighted based on their importance to calculate the final score. Although this example focuses on latency, the same methodology can be applied to other metrics as well. Initially, the system calculates the baseline and deviation values for the customer in Germany (the geo-ID). This calculation uses historical data, typically over a period of 7 consecutive days. The baseline 1102, represented by the average 90th percentile (p90) value, is determined to be 28 milliseconds. This value serves as the upper bound for a score of 70. FIG. 11 is a diagram representing latency of a specific application, in a specific geo-ID, for a specific customer. FIG. 11 illustrates the values used to calculate these percentiles, showing how the baseline was derived from the historical data.

By plotting these values, the system can identify any deviations from the baseline, enabling the system to score the network performance accurately. This approach ensures that the scoring reflects real-world performance and helps in identifying areas that need optimization. Through this method, the customer can maintain optimal network performance in Germany, ensuring that their specific application operates efficiently within this geographic region.

With a baseline and deviation values established, the system can calculate the score for any incoming probe based on the metric value. Let's consider two examples to illustrate this process.

For an incoming probe with End-to-End (e2e) loss of 0 and latency of 55 ms, the system calculates the score using the predefined scoring bins. According to the scoring logic, the latency of 55 ms falls between the bins defined as:

$$score 70 + 3 \times Δ = 51 ms And$$

$$score 70 + 4 \times Δ = 58.6666 ms$$

Since 55 ms lies between these two values, the corresponding score value is determined to be 30.

For another incoming probe with an e2e loss of 0 and latency of 3 ms, the system observes that this latency falls below the upper bound of the score 100 bin, which is defined as:

$$score 70 + 3 \times Δ = 5 ms$$

Since 3 ms is less than 5 ms, the score in this case is assigned a value of 100.

These examples demonstrate how the CloudPath scoring system applies scoring logic based on predefined bins and deviation values to evaluate network performance metrics. By doing so, it provides a clear and quantifiable measure of network health, allowing for the identification and resolution of performance issues. This systematic approach ensures that network performance is continuously monitored and optimized, leading to better overall user experience.

In the context of MTR probes, the network path is divided into multiple segments or legs, each connecting different entities such as the client, egress, broker, node 150, application connector 400, server 200, and others. These segments are critical for understanding the overall network performance, and various strategies can be employed to assign weights to each segment in the scoring process.

One strategy is to assign equal weights to all segments, ensuring a uniform influence on the overall score. However, more nuanced strategies implemented by the present systems involve performing expert analysis to determine the relative importance of each segment. For instance, legs to and from cloud data centers can be given higher weightage to identify if customers are experiencing issues when traversing through the cloud-based system 100 data centers. Similarly, for ZPA (Zscaler Private Access) applications, additional weight can be assigned to the legs involving brokers or application connectors 400, recognizing their critical role in the application performance.

Beyond expert analysis, more sophisticated weighting strategies are implemented using mathematical analysis. This involves examining how each segment's metric values contribute to the overall end-to-end metric values and how these contributions vary over time. By performing regression analysis on this data, the system can determine the exact correlation between individual segment metrics and the end-to-end metrics. This analytical approach allows for the assignment of more precise weights, reflecting the actual impact of each segment on the overall network performance.

Implementing these advanced weighting strategies ensures a more accurate and representative CloudPath score, enabling better identification of performance bottlenecks and more effective network optimization. This method provides a deeper understanding of the network dynamics, leading to improved decision-making and enhanced user experiences.

### § 8.1 Process for Determining and Providing Network Experience Scores

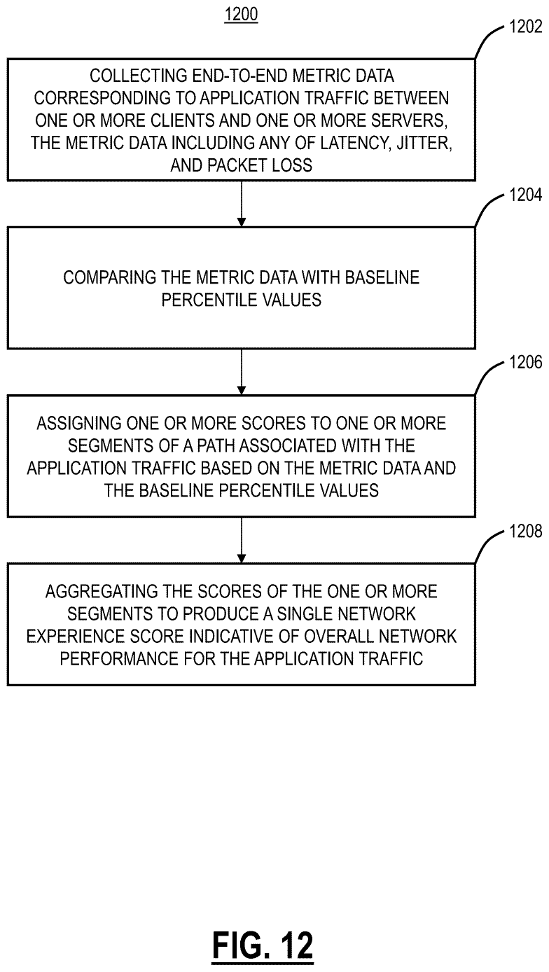

FIG. 12 is a flowchart of a process 1200 for determining and providing network experience scores. The process 1200 can be contemplated as a method having steps, a processing device configured to implement the steps, a cloud-based system configured to implement the steps, and as a non-transitory computer-readable medium storing instructions for programming one or more processors to execute the steps. The process 1200 includes collecting end-to-end metric data corresponding to application traffic between one or more clients and one or more servers, the metric data including any of latency, jitter, and packet loss (step 1202); comparing the metric data with baseline percentile values (step 1204); assigning one or more scores to one or more segments of a path associated with the application traffic based on the metric data and the baseline percentile values (step 1206); and aggregating the scores of the one or more segments to produce a single network experience score indicative of overall network performance for the application traffic (step 1208).

The process 1200 can further include segmenting a network path into discrete path segments, each segment corresponding to at least one leg of the network path between the one or more clients and the one or more servers; collecting segment-specific metric data for each segment; determining segment-specific scores by comparing the segment-specific metric data to the baseline percentile values; and combining the segment-specific scores via a weighted aggregation to form the network experience score. The weighted aggregation assigns different weights to at least two path segments based on any of the criticality of each segment to an end-to-end connection, expert analysis regarding network architecture, and a regression analysis establishing correlation between segment performance and overall network performance. The steps can include establishing baseline percentile values for the metric data by analyzing historical network performance information over a defined period, and wherein the defined period for historical data collection includes a rolling window of at least seven consecutive days. The steps can include establishing distinct baselines for a plurality of geographic identifiers associated with different operating regions; and computing the network experience score for each geographic identifier independently based on respective baseline percentile values. The assigning of one or more scores can include establishing scoring bins bounded by deviation values and mapping current metric measurements to a score according to which scoring bin the measurement falls into. The steps can include applying a machine learning model trained on historical network performance data to predict future network experience scores for application traffic, wherein the machine learning model outputs a predicted score based on real-time metric measurements. The steps can include periodically retraining the machine learning model with newly collected metric data to maintain or improve the accuracy of predicted network experience scores.

### § 9.0 Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAS); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 10.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner-whether collectively, in subsets, or individually-thereby broadening the range of potential embodiments.

What is claimed is:

1. A method comprising steps of:
collecting end-to-end metric data corresponding to application traffic between one or more clients and one or more servers, the metric data including any of latency, jitter, and packet loss;
comparing the metric data with baseline percentile values;
assigning one or more scores to one or more segments of a path associated with the application traffic based on the metric data and the baseline percentile values; and
aggregating the scores of the one or more segments to produce a single network experience score indicative of overall network performance for the application traffic.

2. The method of claim 1, further comprising:
segmenting a network path into discrete path segments, each segment corresponding to at least one leg of the network path between the one or more clients and the one or more servers;
collecting segment-specific metric data for each segment;
determining segment-specific scores by comparing the segment-specific metric data to the baseline percentile values; and
combining the segment-specific scores via a weighted aggregation to form the network experience score.

3. The method of claim 2, wherein the weighted aggregation assigns different weights to at least two path segments based on a criticality of each segment to an end-to-end connection.

4. The method of claim 2, wherein the weighted aggregation assigns different weights to at least two path segments based on expert analysis regarding network architecture.

5. The method of claim 2, wherein the weighted aggregation assigns different weights to at least two path segments based on a regression analysis establishing correlation between segment performance and overall network performance.

6. The method of claim 1, wherein the steps comprise establishing baseline percentile values for the metric data by analyzing historical network performance information over a defined period, and wherein the defined period for historical data collection includes a rolling window of at least seven consecutive days.

7. The method of claim 1, further comprising:
establishing distinct baselines for a plurality of geographic identifiers associated with different operating regions; and
computing the network experience score for each geographic identifier independently based on respective baseline percentile values.

8. The method of claim 1, wherein the assigning of one or more scores comprises establishing scoring bins bounded by deviation values and mapping current metric measurements to a score according to which scoring bin the measurement falls into.

9. The method of claim 1, further comprising applying a machine learning model trained on historical network performance data to predict future network experience scores for application traffic, wherein the machine learning model outputs a predicted score based on real-time metric measurements.

10. The method of claim 9, further comprising periodically retraining the machine learning model with newly collected metric data to maintain or improve accuracy of predicted network experience scores.

11. A non-transitory computer-readable medium comprising instructions that, when executed, cause one or more processors to perform steps of:
collecting end-to-end metric data corresponding to application traffic between one or more clients and one or more servers, the metric data including any of latency, jitter, and packet loss;
comparing the metric data with baseline percentile values;
assigning one or more scores to one or more segments of a path associated with the application traffic based on the metric data and the baseline percentile values; and
aggregating the scores of the one or more segments to produce a single network experience score indicative of overall network performance for the application traffic.

12. The non-transitory computer-readable medium of claim 11, further comprising:
segmenting a network path into discrete path segments, each segment corresponding to at least one leg of the network path between the one or more clients and the one or more servers;
collecting segment-specific metric data for each segment;
determining segment-specific scores by comparing the segment-specific metric data to the baseline percentile values; and
combining the segment-specific scores via a weighted aggregation to form the network experience score.

13. The non-transitory computer-readable medium of claim 12, wherein the weighted aggregation assigns different weights to at least two path segments based on a criticality of each segment to an end-to-end connection.

14. The non-transitory computer-readable medium of claim 12, wherein the weighted aggregation assigns different weights to at least two path segments based on expert analysis regarding network architecture.

15. The non-transitory computer-readable medium of claim 12, wherein the weighted aggregation assigns different weights to at least two path segments based on a regression analysis establishing correlation between segment performance and overall network performance.

16. The non-transitory computer-readable medium of claim 11, wherein the steps comprise establishing baseline percentile values for the metric data by analyzing historical network performance information over a defined period, and wherein the defined period for historical data collection includes a rolling window of at least seven consecutive days.

17. The non-transitory computer-readable medium of claim 11, further comprising:
establishing distinct baselines for a plurality of geographic identifiers associated with different operating regions; and
computing the network experience score for each geographic identifier independently based on respective baseline percentile values.

18. The non-transitory computer-readable medium of claim 11, wherein the assigning of one or more scores comprises establishing scoring bins bounded by deviation values and mapping current metric measurements to a score according to which scoring bin the measurement falls into.

19. The non-transitory computer-readable medium of claim 11, further comprising applying a machine learning model trained on historical network performance data to predict future network experience scores for application traffic, wherein the machine learning model outputs a predicted score based on real-time metric measurements.

20. The non-transitory computer-readable medium of claim 19, further comprising periodically retraining the machine learning model with newly collected metric data to maintain or improve accuracy of predicted network experience scores.
